(19) United States
(12) Patent Application Publication
(10) Pub. No.: US 2008/0306659 A1
(43) Pub. Date: Dec. 11, 2008

(54) Device and Method for Distinguishing a Person From an Object on a Vehicle Seat

(75) Inventors: Manfred Geyer, Regensburg (DE); Gerd Winkler, Regensburg (DE)

Correspondence Address: LERNER GREENBERG STEMER LLP, P O BOX 2480, HOLLYWOOD, FL, 33022-2480, US

(73) Assignee: SIEMENS VDO AUTOMOTIVE AKTIENGESELLSCHAFT, Regensburg (DE)

(21) Appl. No.: 11/910,284

(22) PCT Filed: Mar. 28, 2006
(86) PCT No.: PCT/EP2006/061091

§ 371 Date: Jul. 2, 2008

(30) Foreign Application Priority Data
Mar. 30, 2005 (DE) DE102005014515.9

(51) Int. Cl. B60R 21/015; G01G 19/08

(52) U.S. Cl. 701/46; 177/136

(57) ABSTRACT

A device for differentiating between a person sitting on the seat surface of a vehicle seat and an object includes at least one largely flat bearing surface that is arranged over a large part of the seat surface including a central region. The novel device includes a vehicle seat, a cushion with weight sensors that are distributed over the seat surface of the vehicle seat in a plane manner, and an evaluation unit to which the signals of the weight sensors are supplied. A central region of the seat surface is curved in a concave manner in the direction of the bottom of the vehicle, in such a way that a first weight sensor arranged therein is closer to the bottom of the vehicle than a plurality of second weight sensors arranged in the region of the seat surface covered by the object, outside the central region. The capacity to differentiate between a person and an object is especially useful when the object is a child seat. In this case, the triggering of a passenger retaining means must be prevented.

The invention relates to a device for distinguishing whether a person is seated on the seat surface of a vehicle seat or an object having at least one substantially flat contact surface which is disposed over a large part of the seat surface including a central area. The device comprises a vehicle seat, a seat mat having weight sensors distributed two-dimensionally over the seat surface of the vehicle seat, and an evaluation unit to which the signals of the weight sensors are supplied.

The seat occupancy by vehicle occupants is an important input variable in a plurality of technical applications in motor vehicles. This is true in particular measure for occupant restraint systems whose efficient, i.e. avoiding harm to a person, use of occupant restraining means is often dependent on the seating position of the vehicle occupant.

The publication DE 200 14 200 U1 discloses the use of what is referred to as a sensor seat mat for detecting seat occupancy in a motor vehicle, said sensor seat mat consisting of a plurality of pressure-sensitive sensor elements. These are disposed in a distributed manner over the seating surface of the vehicle seat and can therefore measure the force applied by a person sitting on the vehicle seat or an object located thereon to the seating surface. The sensor elements are resistance elements which change their resistance as a function of the weight acting upon them. Said changes in resistance can be tapped as weight-dependent sensor signals at the resistance elements.

By evaluating the sensor signals in an evaluation unit it is thus possible to produce a seating profile on the basis of which conclusions can be drawn about the seating position of a vehicle occupant, but also about objects which are placed on the seat. The deployment behavior of an occupant restraining means, for example an airbag, may be modified by the control unit of the occupant protection system as a function of the determined seat occupancy, such that optimal protection for the vehicle occupant is ensured based on his or her current seating position. At the same time it may be necessary under certain conditions to suppress the deployment of an occupant restraining means such as e.g. the triggering of an airbag completely if, for example, a vehicle occupant is located too close to the occupant restraining means (airbag) that is to be deployed.

It is often particularly important during the seat occupancy detection function for occupant protection systems to distinguish between different types of objects. For example, it is usually necessary to suppress the deployment of an occupant restraining means (airbag) associated with the vehicle seat in question in a vehicle accident if a child seat, in particular a child seat facing rearward, against the direction of travel, is detected by the seat occupancy detection system. Systems for detecting the seat occupancy on a vehicle seat which use only the sensor signals of a sensor seat mat can often differentiate only with difficulty between, for example, a child seat and a very light person, for example what is referred to as a 5% woman, i.e. a woman who is assumed to be lighter and smaller than 95% of a representative comparative group of women. In the case of a 5% woman, the airbag should nonetheless be deployed in normal circumstances. Above all in the case of a rearward-facing child seat, however, the deployment of an airbag in particular should be prevented, since this could cause injury to a child in the child seat.

For this reason complex additional detection systems are frequently used to provide reliable detection of an object, in particular a child seat, on a vehicle seat. It is known from the publication DE 296 19 668 U1, for example, to dispose transponders in a child seat and transmit and receive antennas in the vehicle seat on which the child seat has been installed. The child seat can be unmistakably detected by way of a communication of the transmit and receive antennas on the vehicle seat with the transponders in the child seat.

However, an additional detection system of this kind for detecting an object, in particular a child seat, on a vehicle seat makes an occupant protection system technically more complicated, thereby usually resulting in higher costs for an occupant protection system and possibly in increased failure probability.

The object of the present invention is to provide a simple device and a simple method for distinguishing whether a person is located on the seat surface of a vehicle seat or an object having an at least substantially flat contact surface, in particular a child seat.

This object is achieved by a device as claimed in claim 1. Said device serves to distinguish whether a person is located on the seat surface of a vehicle seat or an object, in particular a child seat, having an at least substantially flat contact surface which is disposed over a large part of the seat surface including a central area. The device comprises a vehicle seat, a seat mat having weight sensors distributed two-dimensionally over the seat surface of the vehicle seat, and an evaluation unit to which the signals of the weight sensors are supplied. According to the invention the central area of the seat surface is curved in a concave manner in the direction of the floor of the vehicle, such that at least one first weight sensor disposed therein is located closer to the floor of the vehicle than a plurality of second weight sensors which are disposed in the area of the seat surface covered by the object outside the central area.

The invention makes use of the knowledge that the weight of a vehicle occupant in a normal sitting posture is, by virtue of the human anatomy, distributed over the seat surface quite differently than the weight of an object having a substantially flat contact surface. A vehicle occupant typically brings the majority of his or her weight to bear in a central area of the seat surface by way of his or her buttocks pressing on the motor vehicle seat, whereas, in contrast, an object having a substantially flat contact surface can distribute its weight evenly over the seat surface by way of the flat contact surface, in particular if said seat surface is likewise shaped to be substantially flat.

However, if a part of the seat surface which is covered by the object is curved in a concave manner toward the floor of the vehicle, then the weight of the object is not distributed evenly over the seat surface, but only over the points of the seat surface around the concave curvature. A first weight sensor which is disposed within the concavely curved central sub-area of the seat surface is therefore subjected to very much less weight than such second weight sensors which are disposed outside said concavely curved central area and which, although covered to the same extent by the object, are in direct contact with the substantially flat contact surface of the object. By means of a simple comparison of the signal of the first weight sensor or of a plurality of first weight sensors with the signal of a plurality of second weight sensors to which comparatively more weight is applied by the object it is possible to provide a very reliable detection of such an object, in particular of a child seat, compared to a person. This is because, conversely, a person will apply more weight precisely to the first weight sensor(s) than the second weight sensors outside the curved central area of the seat surface.

For a reliable detection of a described object, in particular a child seat, according to the invention, it is advantageous that the curvature of the seat surface of the vehicle seat is embodied in such a way that less than 5%, preferably less than 30% or even less than 50% of the weight loading caused by the object acts upon the first weight sensor or the first weight sensors than on at least one second weight sensor which is completely covered by the object.

It is particularly advantageous in this case if the first weight sensor or the first weight sensors experiences or experience no weight loading due to such an object. In that case it is particularly easy to distinguish the signals of the second weight sensors subjected to load from those of an unloaded first weight sensor or a plurality of unloaded first weight sensors.

The object is further achieved by a method as claimed in claim 6 for distinguishing whether a person is located on the seat surface of a vehicle seat or an object having at least one substantially flat contact surface which is disposed over a large part of the seat surface including a central area, wherein the method employs a device comprising a vehicle seat, a seat mat having weight sensors distributed two-dimensionally on the seat surface of the vehicle seat, and an evaluation unit to which the signals of the weight sensors are supplied. The following steps are executed in the method according to the invention: the signal of at least one first weight sensor which is disposed in the central area of the seat surface is recorded; in addition, the signals of a plurality of second weight sensors which are disposed in the area of the seat surface that is covered by the object but located outside the central area are recorded; the signal(s) of the first weight sensor(s) is (are) compared with the signals of the second weight sensors; the object is detected as soon as the signal of the first weight sensor or the signals of the first weight sensors, for example individually or in total, amounts to less than 5% of the signal of at least one signal of a second weight sensor, preferably less than 30%, in particular less than 50%.

The comparison of the signals of the weight sensors can be conducted for example as a comparison of a first weight sensor with an average value of the signals of the second weight sensors. With a plurality of first weight sensors, an average value of the signals of the first weight sensors can also be used for the comparison instead. However, the signals of the first and second weight sensors can also be compared with one another individually in each case, possibly also combined with a comparison of average values. The object is detected on the basis of the result of this comparison or these comparisons of the signals of the weight sensors.

A further advantageous method when a plurality of first weight sensors are used is set forth in claim 7.

Even though the method according to the invention can also be used in other fields of automotive engineering, said reliable and simple method is particularly advantageous for use in occupant protection systems in which, when an object having a substantially flat contact surface is detected, the activation of an occupant restraining means should always be inhibited, preferably when a child seat is detected as the object. It is also conceivable, however, that other detected objects are to lead to the deactivation of an occupant restraining means. For example, the method could also be advantageously used for detecting large packages or the like which likewise have a substantially flat contact surface. Triggering an occupant restraining means would be unnecessary in the case of an object of this kind and would only result in high consequential costs due to a repair of the vehicle after deployment of the occupant restraining means. Non-deployment of the restraining means is therefore to be preferred.

The invention is explained below with reference to a number of figures, in which:

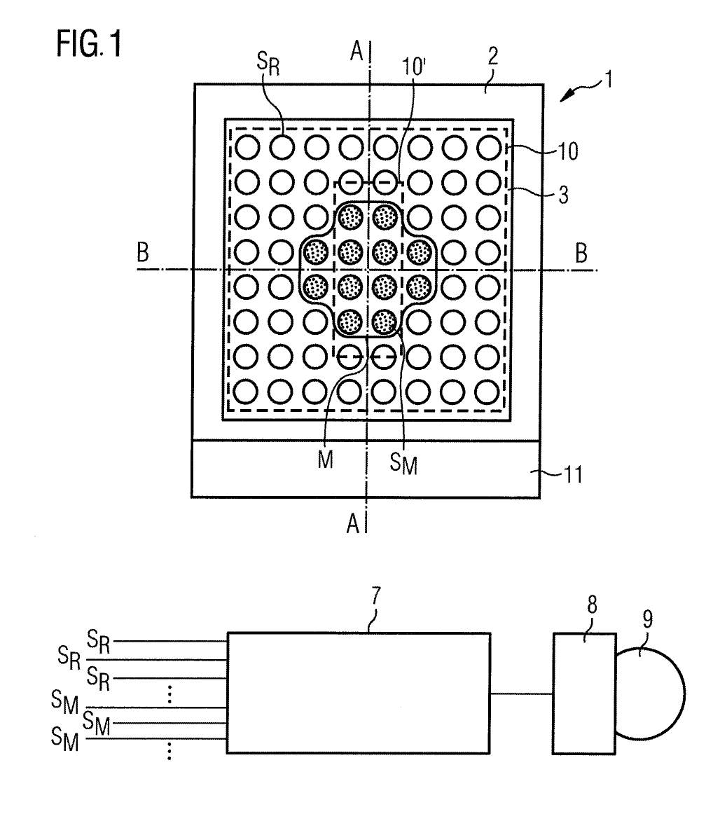

FIG. 1 shows a device according to the invention, comprising a motor vehicle seat with a seat line and a seat surface in plan view,

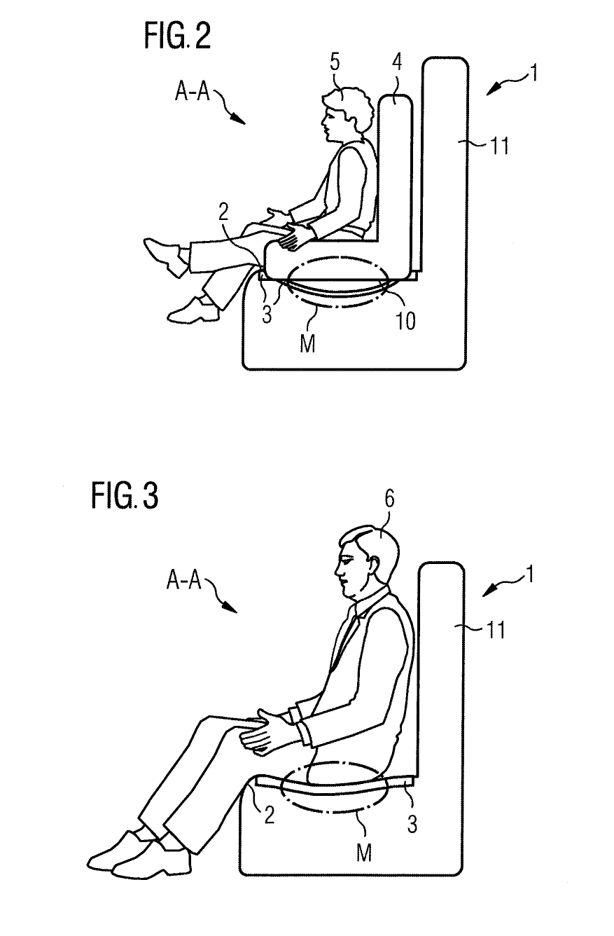

FIG. 2 shows the motor vehicle seat from FIG. 1 in cross-section with a child seat on its seat surface,

FIG. 3 shows a vehicle seat as in FIG. 2, but with a person on the seat surface, and

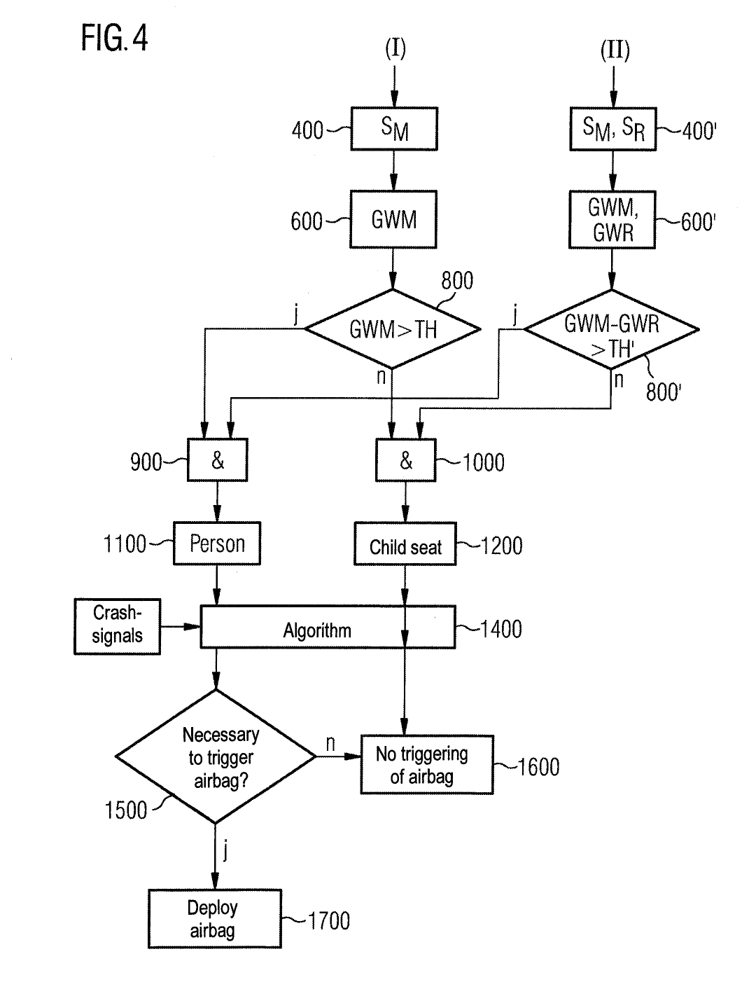

FIG. 4 shows a method according to the invention.

FIG. 1 shows an exemplary embodiment of an inventive device comprising a motor vehicle seat 1 with a seat backrest 11 and a seat surface 2 in plan view; arranged thereon is a seat mat 3 which has weight-sensitive sensors S_{R}, S_{M} at each of which a sensor signal can be tapped by an evaluation unit 7, thus providing information about the weight forces acting upon said sensors S_{R} and S_{M}. A bordered area identified by the reference character M represents a planar central area of the seat surface 2 in which planar central weight sensors S_{M} are disposed.

The evaluation unit 7 is connected to a triggering unit 8 which can effect the deployment of an occupant protection means 9, for example a front airbag, if the signals of impact sensors (not shown), for example acceleration or pressure sensors, are characteristic of an impact accident.

A square surface area 10 (represented by a dashed line) on the seat surface 2 represents the substantially flat contact surface of a child seat 4. Depending on the embodiment of the child seat 4, the substantially flat contact surface does not necessarily have to occupy the entire closed surface area 10 in this case. The flat surface area 10 may be interrupted by a recess.

FIG. 2 shows the motor vehicle seat 1 from FIG. 1 in cross-section along the cross-section line A-A. The child seat 4, in which a child 5 is seated, is disposed on the seat surface 2. In the central area M the seat surface is curved in a concave manner in the direction of the floor of the vehicle. The flat contact surface 10 of the child seat 4 covers far more than the area M of the curved seat surface 2, with the result that the weight of the child seat acts only upon those areas of the seat surface 2 which are located outside the curved area M. The weight of the child seat 4 and the child 5 is therefore recorded only by weight sensors S_{R} outside said central area M. Only these weight sensors S_{R} therefore supply in each case a weight-dependent signal that can be measured by the evaluation unit 7.

The sensors S_{M} in the central area M are not subjected, or subjected only very slightly, to the weight of the child seat 4 and the child 5 in comparison with the plurality of the weight sensors S_{R} outside said central area M.

FIG. 3 shows a person 6 on the vehicle seat 1. The buttocks of the person 6 impose a much heavier load on the central area M of the seat surface 2 of the vehicle seat 1 than on the surrounding edge-side parts of the seat surface 2. Comparatively more weight is applied at that point to the seat surface 2 than outside said central area M, with the result that the central concave curvature in the central area M of the seat surface increases in addition in the direction of the vehicle floor.

The floor of the vehicle interior usually takes a further part of the weight of the person 6, since that is usually where the legs of the person are positioned; furthermore, the seat backrest 11 also takes some weight, since the person 6 usually leans against the seat backrest 11. Often the armrests, steering wheel etc. also take a part of the weight of the vehicle occupant, since the latter preferably rests his or her arms at these points or holds on at these points, etc.

FIG. 4 shows an exemplary embodiment of a method according to the invention.

In a first method section I, in a method step 400, the evaluation unit 7 records the signals of the planar central first weight sensor S_{M}. From said sensor signals, in method step 600, a weight value GWM is derived which is characteristic of the weight loading on the planar central area M of the seat surface 2. For example, an average value, additionally weighted if necessary, of the sensor signals of the planar central weight sensors S_{M} can be formed. In a further method step 800, the obtained value GWM is compared with a threshold value TH.

In a second method section II which takes place simultaneously with or offset in time relative to the first method section I, in a method step 400′ the sensor signals of the second weight sensors S_{R} outside the central area M of the seat surface 2 are determined, as well as the sensor signals of the first weight sensors, if this did not already take place in method step 400.

In a next method step 600′, if this did not already take place in method step 600, a value GWM is derived from the signals of the first weight sensors, said value being characteristic of the weight loading on the center of the surface area. Similarly, a corresponding value GWR is determined from the signals of the second weight sensors S_{R}, said value being characteristic of the weight loading outside the central area M of the seat surface 2.

In a next method step 800, the difference between the two values GWM and GWR is compared with a threshold value TH′. If this difference exceeds the threshold value TH′, for example by 5%, 30%, 50% or even more, this is an indication that a person 6 could be located on the seat surface 2 and not an object. If the value GWM also exceeds the threshold value TH, this is a further indication that a person 6 is seated on the vehicle seat. In a method step 900, these two indications are logically combined with one another and as the result, in a further method step 1100, the presence of a person 6 on the seat surface 2 is detected.

If, on the other hand, the difference between the two values GWM and GWR is less than the threshold value TH′, then it is to be assumed that for example a child seat 4 is disposed on the seat surface 2. If the value GWM simultaneously falls below the threshold value TH, this is to be regarded as a further indication thereof. In a method step 1000, these two pieces of information are therefore logically combined with one another and the presence of a child seat 4 on the seat surface 2 is established in a further method step 1200.

The information concerning whether a person 6 or a child seat 4 is present on the seat surface 2 of the motor vehicle seat is supplied to the evaluation unit 7 for evaluation by a stored special algorithm. This is represented in FIG. 5 by method step 1400. The algorithm of the evaluation unit is also supplied with crash signals from suitable crash sensors, which crash signals can be evaluated by the algorithm. Based on this evaluation, information on whether an accident situation is present or not is available in the evaluation unit.

In a further method step 1500, the algorithm therefore takes the decision on whether the triggering e.g. of an airbag is necessary or not. If no triggering of an airbag is necessary based on the crash signals, the evaluation unit 17 decides in a further method step 1600 that no triggering of the airbag will take place.

If a child seat 4 was detected on the seat surface 2, an airbag will not be deployed in any event, not even if crash signals point to a vehicle accident. This is indicated in FIG. 5 by the arrow which is continued through the box which represents method step 1400 for the algorithm.

If, however, the triggering of an airbag is necessary and if a person has simultaneously been detected on the vehicle seat, the evaluation unit 7 decides in a further method step 1700 that an airbag is to be deployed.

1-9. (canceled)

10. A device for distinguishing whether a person is seated on a seat surface of a vehicle seat or an object is disposed thereon, the object having a substantially planar contact surface covering a large part of said seat surface, including a central area thereof, the device comprising:
a vehicle seat having the seat surface with the central area;
a seat mat carrying a plurality of weight sensors distributed two-dimensionally over said seat surface, said weight sensors including at least one first weight sensor disposed in said central area and a plurality of second weight sensors disposed outside said central area;
said central area of said seat surface being concavely curved downward in a direction of a vehicle floor, causing said at least one first weight sensor disposed in said central area to be closer to the vehicle floor than a plurality of second weight sensors disposed in an area of said seat surface that is covered by the object and is located outside said central area; and
an evaluation unit configured to receive measurement signals from said weight sensors.

11. The device according to claim 10, wherein said seat mat is configured such that less than 50% of the proportional weight loading due to the object imposes a load on said first weight sensor than on at least one other second weight sensor covered by the object.

12. The device according to claim 10, wherein said seat mat is configured such that less than 30% of the proportional weight loading due to the object imposes a load on said first weight sensor than on at least one other second weight sensor covered by the object.

13. The device according to claim 10, wherein said seat mat is configured such that less than 5% of the proportional weight loading due to the object imposes a load on said first weight sensor than on at least one other second weight sensor covered by the object.

14. The device according to claim 10, wherein said first weight sensor is disposed so as not to be subjected to load due to the weight of the object.

15. The device according to claim 10, wherein said first weight sensor is one of a plurality of first weight sensors.

16. The device according to claim 10, wherein the object is a child seat.

17. A method for distinguishing whether a person is seated on a seat surface of a vehicle seat or an object with a substantially flat contact surface extending over a large part of the seat surface, including a central area thereof, is disposed on the seat surface, the method which comprises:
providing a device having: a vehicle seat, a seat mat carrying a plurality of weight sensors distributed over the seat surface of the vehicle seat, and an evaluation unit connected to receive signals of the weight sensors;
recording a first signal of at least one first weight sensor disposed in the central area of the seat surface;
recording second signals of a plurality of second weight sensors disposed in an area of the seat surface covered by the object and located outside the central area;
comparing the first signal of the first weight sensor with the second signals of the second weight sensors;
determining that the object is disposed on the seat if the signal of the first weight sensor is appreciably less than at least one second signal of the second weight sensor.

18. The method according to claim 17, which comprises determining that the object is present on the seat when the first signal is less than 5% of at least one second signal.

19. The method according to claim 17, which comprises determining that the object is present on the seat when the first signal is less than 30% of at least one second signal.

20. The method according to claim 17, which comprises determining that the object is present on the seat when the first signal is less than 50% of at least one second signal.

21. The method according to claim 17, which comprises:
providing the seat mat with a plurality of first weight sensors;
recording the first signals of a plurality of the first weight sensors;
comparing the first signals of the first weight sensors with the second signals of the second weight sensors;
detecting the object as soon as at least one signal of a first weight sensor is less than 5% of at least one second signal of a second weight sensor.

22. The method according to claim 21, which comprises detecting the object as soon as at least one first signal is less than 30% of at least one second signal.

23. The method according to claim 21, which comprises detecting the object as soon as at least one first signal is less than 50% of at least one second signal.

24. The method according to claim 17, which comprises, if the object is detected, preventing an activation of an occupant restraining means.

25. The method according to claim 17, wherein the object is a child seat.
